(19) United States
(12) Patent Application Publication
(10) Pub. No.: US 2025/0196428 A1
(43) Pub. Date: Jun. 19, 2025

(54) METHOD FOR MANUFACTURING A THREE-DIMENSIONAL ITEM WITH METAL PATTERN(S)

(71) Applicant: JET METAL TECHNOLOGIES, CHAMPAGNE-AU-MONT D'OR (FR)

(72) Inventor: Samuel Paul Henry STREMSDOERFER, COLLONGES AU MONT D'OR (FR)

(21) Appl. No.: 18/843,387

(22) PCT Filed: Mar. 3, 2023
(86) PCT No.: PCT/FR2023/050289

§ 371 Date: Sep. 3, 2024

(30) Foreign Application Priority Data
Mar. 4, 2022 (FR) FR2201910

(51) Int. Cl. B29C 51/42; C23C 18/16; C25D 5/00; C25D 5/02; C25D 5/56

(52) U.S. Cl. CPC B29C 51/421; C23C 18/1605; C23C 18/1641; C25D 5/022; C25D 5/56; C25D 5/60; B29K 2995/0097

(57) ABSTRACT

The invention relates to a method for manufacturing a three-dimensional item comprising at least one metal pattern, comprising at least:
a step A of providing a flat substrate of thermoformable material;
a step B of forming on a surface of the flat substrate a temporary masking coating that adheres to said surface, to obtain a masked substrate having at least one unmasked area;
a step C of thermoforming the flat substrate to give the latter a generally three-dimensional shape;
a step D of metallizing the masked substrate to form a metal deposit on the latter, at least on said unmasked area;
and a step E of eliminating said temporary masking coating,
the thermoforming step C being carried out before metallization step D and before step E of eliminating said temporary masking coating, the metallization step D being carried out by non-electrolytic deposition from one or more metallization solution(s) containing at least one metal in metal cation form and at least one reducing agent adapted to transform the metal cation into metal, by spraying the metallization solution(s) in the form of one or more aerosol(s).

Method for manufacturing three-dimensional items with metal pattern(s)

### TECHNICAL FIELD

The present invention relates to the general technical field of three-dimensional items with decorative and/or functional metal pattern(s).

More particularly, the invention relates to a method for manufacturing a three-dimensional item comprising at least one metal pattern.

### PRIOR ART

In the field of manufacture of objects decorated with metal patterns, methods are known, which consist in making or applying metal patterns on the surface of a semi-finished three-dimensional object, such as, for example, a glass or plastic vial or bottle, by additive techniques (e.g. screen printing or pad printing using a metallized ink, or application of a metal film by hot stamping) or subtractive techniques (e.g. object surface metallizing then selective laser engraving). Although these techniques can produce particularly aesthetic decorative effects, they are nevertheless costly and difficult to use for large-scale designs. Moreover, they are very difficult, if not impossible, to use for decorating semi-finished three-dimensional objects of complex geometry/topography, so that they are generally implemented only on substantially flat or cylindrical surface portions of prefabricated semi-finished three-dimensional objects.

In the field of printed electronics, methods are known for manufacturing three-dimensional items or objects locally covered with electrically conductive metallizations, in which conductive patterns are produced on a thermoplastic polymer substrate by direct printing (screen or ink jet printing) using an electrically conductive ink, such as in particular an ink containing silver particles. A heat and/or actinic treatment is then applied to evacuate a solvent contained in the ink and/or to cross-link a polymer matrix of the ink. The substrate is then thermoformed to be given the desired three-dimensional aspect. In addition to the fact that implementing an electrically conductive ink is rather expensive, the electric performance of the conductive patterns obtained using such an ink can still be improved, particularly in terms of level and homogeneity of the electrical conductivity, which may in some cases prove problematic for the correct operation of an electronic device integrating such a three-dimensional object.

### DISCLOSURE OF THE INVENTION

The objects assigned to the invention therefore aim to provide a response to the above-mentioned needs and issues, and to propose in particular a new method for easily and efficiently manufacturing three-dimensional items with decorative and/or functional metal pattern(s), in a wide variety of shapes and geometries.

Another object of the invention aims to propose a new method that makes it possible to manufacture three-dimensional items with metal pattern(s) of any size.

Another object of the invention aims to propose a new method that makes it possible to manufacture three-dimensional items with metal pattern(s) in a quick and relatively inexpensive manner.

Another object of the invention aims to propose a new method for manufacturing three-dimensional items with metal pattern(s) that is simple to implement.

Another object of the invention aims to propose a new method for manufacturing three-dimensional items with metal pattern(s) that can be industrially implemented.

Another object of the invention aims to propose a new method for manufacturing three-dimensional items whose metal pattern(s) are likely to be fine, precise and complex.

Another object of the invention aims to propose a new method for manufacturing three-dimensional items whose metal pattern(s) are particularly resistant to external aggressions.

Another object of the invention aims to propose a new method for manufacturing three-dimensional items whose metal pattern(s) are particularly homogeneous and regular, both in terms of thickness and surface appearance.

Another object of the invention aims to propose a new method for manufacturing three-dimensional items with metal pattern(s), which enables an excellent control over the shape of the metal pattern(s).

The objects assigned to the invention are achieved by means of a method for manufacturing a three-dimensional item comprising at least one metal pattern, comprising at least:
a step A of providing a flat substrate of thermoformable material;
a step B of forming on a surface of the flat substrate a temporary masking coating that adheres to said surface, to obtain a masked substrate having at least one unmasked area;
a step C of thermoforming the flat substrate to give the latter a generally three-dimensional shape;
a step D of metallizing the substrate to form a metal deposit on the latter;
and a step E of eliminating said temporary masking coating.

### BRIEF DESCRIPTION OF THE DRAWINGS

Other features and advantages of the invention will appear in more detail upon reading of the following description, with reference to the appended drawings, given by way of purely illustrative and non-limiting examples, in which:

FIG. 1 illustrates, in the context of a first example of implementation of a method in accordance with the invention for manufacturing a three-dimensional RFID antenna, a flat substrate whose surface is covered with a temporary masking coating that adheres to said surface, thus forming a masked substrate having at least one unmasked area, designed to receive a metal deposit;

FIG. 2 illustrates a thermoformed masked substrate, obtained after subjecting the masked flat substrate of FIG. 1 to a thermoforming step in accordance with the invention;

FIG. 3 illustrates a thermoformed substrate whose surface is provided with a metal pattern in solid silver forming an RFID antenna electrode, obtained after subjecting in particular the thermoformed masked substrate of FIG. 2 to a metallizing step and a step of eliminating the temporary masking coating in accordance with the invention;

FIG. 4 illustrates, in the context of a second example of implementation of a method in accordance with the invention for manufacturing a three-dimensional item with decorative metal patterns, a flat substrate whose surface is covered with a temporary masking coating that adheres to said surface, thus forming a masked substrate having at least one unmasked area, designed to receive a metal deposit;

FIG. 5 illustrates a metallized masked substrate, obtained after subjecting the masked flat substrate of FIG. 4 to a metallizing step and a step of eliminating the temporary masking coating in accordance with the invention;

FIG. 6 illustrates a thermoformed metallized substrate, whose surface is provided with a plurality of decorative metal patterns in solid silver, obtained after subjecting the metallized masked flat substrate of FIG. 5 to a thermoforming step in accordance with the invention.

### BEST WAY TO IMPLEMENT THE INVENTION

The invention relates to a method for manufacturing a three-dimensional item comprising at least one metal pattern (or “metallized pattern”). As used herein, “three-dimensional” means a physical object that expands substantially in the three dimensions of space, along distances that are non-negligible from one another. The shape and sizes of the metal pattern(s) are not particularly limited, and may depend in particular on the intended application of the three-dimensional item and on the metal pattern(s) carried by the latter. Advantageously, the metal pattern(s) concerned are decorative and/or functional, and therefore form or contribute to form, for example and without limitation, one or more printed circuits, one or more integrated circuits on a semi-conductive substrate, one or more sensor/detector electrodes, one or more electrodes of an electric heater/defroster device, one or more radio-frequency antennas (WiFi®, RFID, etc.), one or more encoding pictograms able to be read by electronic devices, one or more figurative and/or scriptural information items identifying a product that incorporates or with which is associated said three-dimensional item, in particular a commercial product, such as a visual or decorative design on a packaging, on a car product, etc.

The manufacturing method in accordance with the invention comprises at least the following steps:
a step A of providing a flat substrate of thermoformable material;
a step B of forming on a surface of the flat substrate (i.e. a surface of at least one side of the later) a temporary masking coating that adheres to said surface, to obtain a masked substrate having at least one unmasked area (“selective” temporary masking coating). Advantageously, said unmasked area is an area of the surface of said flat substrate side that carries the temporary masking coating (and not, for example, an area of a surface on the side of the flat substrate that is opposite to the side carrying the temporary masking coating);
a step C of thermoforming the flat substrate to give the latter a generally three-dimensional shape;
a step D of metallizing the substrate to form a metal deposit on the latter, thus at least on the unmasked area;
a step E of eliminating said temporary masking coating. It is preferably a complete elimination of said temporary masking coating, the three-dimensional item obtained at the end of the manufacturing method being therefore advantageously fully devoid of said temporary masking coating.

Thanks to the method according to the invention, which cleverly proposes to form a temporary (selective) masking coating adhering to the surface of a flat substrate of thermoformable material, previously to a step of thermoforming this flat substrate, for making a selective metallization of the substrate, it thus becomes advantageously possible to manufacture in a particularly simple and efficient way three-dimensional items with decorative and/or functional metal pattern(s), in a wide variety of shapes and geometries. In particular, it thus becomes advantageously possible to manufacture in a particularly simple and efficient way items whose substrate, but also the decorative and/or functional metal pattern(s), have a non-flat three-dimensional shape. Indeed, it is much easier in practice to make a temporary masking on a flat substrate than on a three-dimensional substrate, especially with a complex shape/geometry, and the use of such a temporary masking coating then enables to easily and precisely metallize a wide variety of substrates of thermoformable material, according to a plurality of conceivable metallization techniques.

The invention covers various embodiments, as will become clear from the following, which are based on the general principle of using a (selective) temporary masking coating formed on the flat substrate and adhering to the surface of the latter to delimit particular areas of the substrate that, at the end of the method, will carry one or more metal pattern(s). In some cases, the temporary masking coating may be intended to allow a selective activation of the substrate surface, so that only at least one area of the substrate surface that is not masked by the temporary masking coating will be activated and will be able, during the metallization step D, to receive a metal deposit to form one or more metal pattern(s). In other cases, in particular when it is not necessary to activate the substrate surface for its subsequent metallization, the metallization step D may be a step of metallizing the masked substrate to form a metal deposit on the latter at least on said unmasked area. At the end of step E of eliminating the temporary masking coating, only said unmasked area will carry a metal deposit forming or intended to form the desired metal pattern(s).

The method may further possibly comprise in particular all or part of the following additional steps (and not necessary in the following order):
at least one step F of preparing the substrate surface;
a step G of defining a two-dimensional masking pattern, along which the temporary masking coating is then formed on the flat substrate surface in step B, by modelling the deformation of the flat substrate in thermoforming step C and representing the metal pattern(s) to be obtained at the surface of the thermoformed substrate;
a step H of activating the substrate surface, in particular the unmasked area(s) intended to carry the metal pattern(s);
a step I of rinsing the surface of the metallized substrate;
a step J of drying the surface of the metallized substrate;
one or more step(s) K, L, M of finishing treatment of the metallized substrate surface, and/or more specifically of the metal deposit or of the metal pattern(s) formed on this surface;
a step N of over-moulding the thermoformed substrate;
a step O of assembling additional components.

Within the meaning of the invention, “flat substrate” advantageously means a substrate of generally substantially two-dimensional shape, i.e. extending essentially in two of the three directions of space, and to a lesser extent in the third direction in space. Typically, such a flat substrate can thus take the shape of a film, a sheet or a plate. “Thermoformable material” advantageously means a material that can be shaped, deformed, by being heated, i.e. a material that can be given a particular shape after being heated to a suitable temperature (forming temperature) to soften it, and that, after cooling and curing, keeps the shape it has been given. If the flat substrate is not already pre-existing prior to the implementation of the method according to the invention, then step A of providing the flat substrate (hereinafter abbreviated to “step A”) may comprise manufacturing such a flat substrate from a chosen thermoformable material. Generally, and according to the intended applications, the flat substrate can be made of a non-conductive/dielectric thermoformable material, a semi-conductive thermoformable material or a conductive thermoformable material (intrinsically or as a result of a treatment that has made it conductive).

Step B of forming a temporary masking coating (or “temporary masking coating”) (hereinafter abbreviated to “step B”) aims, as introduced hereinabove, to delimit on the substrate surface, one or more particular area(s) that, not having been masked by the temporary masking coating, will carry the desired metal pattern(s) at the end of metallization step D, thermoforming step C and step E of eliminating the temporary masking coating. Conversely, the substrate area(s) that was (were) previously masked by the temporary masking coating will be devoid of metal deposit, and hence of metal pattern(s), at the end of the steps of metallization, thermoforming and elimination of the temporary masking coating. Within the meaning of the invention, the temporary masking coating is a coating that adheres to the substrate surface, either directly on the bare surface of the latter, or possibly indirectly via an intermediate coating adhering to the substrate surface and to which the temporary masking coating adheres in return. In any case, the temporary masking coating is thus not a mechanical mask/stencil (such as a silkscreen mask, for example) that would be simply affixed, applied, in contact with said surface. It is further understood that the temporary masking coating is not intended to form, or contribute to form, said metal deposit and metal pattern(s).

Thermoforming step C (hereinafter abbreviated to “step C”) generally consists in hot deforming the flat substrate, in an advantageously controlled manner, in order to give the latter an advantageously predefined, generally three-dimensional shape. In particular, step C aims to deform the flat substrate at least locally and at least along a direction secant to a mean plane of extension of said flat substrate.

As a variant (hereinafter “variant V1”), thermoforming step C is carried out before metallization step D.

As a first sub-variant (hereinafter “variant V1a”) of this variant V1, thermoforming step C is moreover preferentially carried out before step E of eliminating the temporary masking coating. In this case, step C is thus a step of thermoforming the not-yet-metallized masked flat substrate, in which the flat substrate and the temporary masking coating are simultaneously thermoformed (or thermodeformed), previously to carrying out step D of metallizing the so-thermoformed masked substrate. For that purpose, the temporary masking coating is thus itself advantageously thermoformable, or at least thermodeformable, so as to be able to undergo an elongation and thus follow the deformation of the flat substrate, while adhering to the surface of the latter, during thermoforming step C. The temporary masking coating is thus advantageously designed, in particular in terms of capacity of elongation/deformation without breaking, to be capable of undergoing the conditions for carrying out step C of thermoforming the flat substrate, without significant degradation of its function of masking the surface of the latter. Therefore, if the shape and/or the surface area of the unmasked area(s) can be modified by thermoforming step C, the temporary masking coating nevertheless remains substantially cohesive and film-forming, so that in particular no additional unmasked area is involuntarily generated by the deformation of the temporary masking coating during thermoforming step C. For the sake of simplicity, “unmasked areas(s)” will refer indifferently hereinafter to one or more unmasked area(s) of the masked substrate, whether the latter is thermoformed or not.

As a second sub-variant (“variant V1b) of this variant V1, step C is carried out after step E of eliminating the temporary masking coating, for example in the case where said temporary masking coating is intended to enable a selective activation of the substrate surface in an activation step H previous to metallization step D. In this case, step C is thus a step of thermoforming the flat substrate, devoid of said temporary masking coating and not yet metallized, previously to carrying out step D of metallizing the so-thermoformed masked substrate.

Insofar as, in this variant V1, the metal deposit is formed on the substrate surface after the latter has been thermoformed, the metal deposit thus does not undergo the mechanical deformation and the warming to which the flat substrate is subjected in thermoforming step C. It is therefore advantageously possible to manufacture a three-dimensional item with particularly marked and/or complex shapes and geometries, thus implying for that purpose a significant deformation of the flat substrate during the thermoforming, without risk that step C leads to a degradation (delamination, (micro)-cracking, etc.) of the metal deposit quality, and in particular of the properties thereof in terms of electrical conductivity. It becomes in particular advantageously possible to subject the flat substrate to a deformation rate higher than or equal to 200% in thermoforming step C. Such a variant V1 is particularly advantageous in particular in the case where it is desired to obtain a three-dimensional item comprising one or more metal patterns for functional purposes, such as forming in particular one or more conductive metal tracks of printed circuit, one or more sensor/detector electrodes or one or more radio-frequency antennas.

As another variant (hereinafter “variant V2”), thermoforming step C is carried out after metallization step D. In this variant V2, step C is thus a step of thermoforming the metallized flat substrate, in which the flat substrate and the metal deposit formed at the surface thereof thus undergo deformation simultaneously. Although it is possibly conceivable (“variant V2a») that the temporary masking coating is present on the surface of the flat substrate during thermoforming step C, this is not strictly necessary. On the contrary, it is even advantageous that, in this variant V2, step E of eliminating the temporary masking coating is carried out before thermoforming step C (“variant V2b”), so as to avoid that a deformation of the temporary masking coating possibly degrades the metal deposit.

In this variant V2, the temporary masking coating forming step B and the metallization step D are thus both carried out on the flat substrate. Implementation of theses steps B and D is therefore simplified, as said steps B and D can be easily carried out on line in an industrial context. That being said, it is preferable to keep this variant V2 for the manufacturing of three-dimensional items requiring a limited deformation of the metallized substrate in thermoforming step C, in order to limit the risk of degradation of the metal deposit quality during the thermoforming, that would lead to ruptured or inhomogeneous conductive properties of the metal pattern(s), and/or for the manufacturing of three-dimensional items whose metal pattern(s) are essentially decorative.

Carried out after step B, metallization step D (hereinafter abbreviated to “step D”) consists in forming on the substrate surface, and at least on the area(s) that are not masked by the temporary masking coating or on one or more substrate area(s) corresponding to the area(s) not masked by the temporary masking coating, a metal deposit intended to form all or part (i.e. alone or possibly in combination with a complementary metal deposit, for example) of the desired metal pattern(s). As used herein, “metal deposit” generally means a deposit, a layer, comprising—or formed of—at least one metal or metallic substance, here understood as at least one elemental metal (or “elemental simple body”), at least one mixture of elemental metals, at least one metal alloy and/or at least one metal oxide.

Advantageously, metallization step D is carried out so that the metal deposit obtained at the end of the latter comprises at least one metal (or “metallic substance”) chosen among the group comprising: an elemental metal such as silver Ag, gold Au, nickel Ni, copper Cu, iron Fe, stain Sn, cobalt Co, an alloy of these latter, a mixture of two or more of these elemental metals, or one or more oxides of one at least of these elemental metals.

Advantageously, in particular in terms of electrical conductivity properties and/or in terms of decorative properties (e.g., “mirror” effect) of the metal pattern(s), metallization step D is carried out so that the metal deposit is made of solid metal, possibly filled with additional particles (or “fillers”) which may be organic or inorganic. In this case, the metal deposit is thus essentially—if not totally, to within the inevitable non-metallic impurities—formed of metal (or “metallic substance”), as defined hereinabove. Thus, “metal deposit of solid metal” here advantageously means in particular that the metal deposit is advantageously devoid of polymer matrix. This enables in particular to obtain a metal pattern whose properties remain particularly stable over time, unlike a pattern comprising a polymer matrix in which metal particles are dispersed, wherein said polymer matrix would then be liable to degrade progressively under the effect, for example, of light, heat, etc., thus leading to a drift in the properties of the metal pattern over time. Advantageously, the solid metal can be made of a single elemental metal (typically by more than 90%, preferably more than 95%, and still preferably more than 98%). For example, the metal deposit can thus be formed of a pure elemental metal, for example pure silver Ag (preferably, by more than 95%, and still preferably more than 98%), and possibly additional particles. As the case may be, said solid metal forms a solid (metal) matrix within which said additional particles are dispersed. Said additional particles are preferentially chosen with a characteristic size of less than 100 μm. Generally, the implementation of such additional particles aims to modify the physical properties (i.e. mechanical/tribological, electrical and/or optical properties) and/or the intrinsic chemical properties of the solid metal that is filled therewith. Non-limiting examples of additional particles liable to be included, alone or in mixture, in a metal deposit of solid metal, are: particles of diamond carbon, particles of silicon carbide SiC, particles of molybdenum disulphide MoS₂, particles of one or more rare earth(s) or rare earth oxide(s), particles of graphene, particles of a fluoropolymer (such as, for example, polytetrafluoroethylene (PTFE)), particles of an elemental metal or metal oxide(s), etc.

The metal deposit may be single-layer or multi-layer, depending on the desired properties and the intended applications of the metal pattern(s). Advantageously, step D is made in such a way that the metal deposit has, at the end of said metallization step D, a thickness of between 10 nm and 5 μm, preferably between 10 nm and 1 μm, and still preferably between 10 nm and 500 nm. According to a variant, step D is carried out so that the thickness of the metal deposit obtained at the end of step D is substantially constant over the whole extend of said metal deposit, that is to say that the thickness is substantially the same at any point of the metal deposit. It is therefore possible to obtain one (or more) metal pattern(s) with a substantially constant thickness over the whole extent of the metal pattern(s). According to another variant, step D is carried out so that the thickness of the metal deposit obtained at the end of step D is variable over the extent of said metal deposit (while remaining preferentially in the above-mentioned ranges of values), that is to say that the metal deposit has at least a first area and a second area, distinct from each other, the thickness of the metal deposit increasing or on the contrary decreasing (thickness gradient) from said first area to said second area. Such a thickness variation of the metal deposit thus advantageously enables to obtain one (or more) metal pattern(s) that define areas of different electrical conductivity or resistivity, or of different transparency or reflectivity to electromagnetic waves (e.g. visible light, IR or UV, radio-frequency waves, etc.), which may be of particular interest depending on the intended functional and/or decorative applications.

Different metallization methods, and in particular different so-called “wet” or “dry” methods, can be contemplated for carrying out metallization step D. The main so-called “dry” methods contemplated herein include “Physical Vapour Deposition” (PVD) and “Chemical Vapour Deposition” (CVD) techniques. However, these techniques have for major drawback the need to vacuum the substrate to carry out the metallization. It is therefore preferable that metallization step D implements one or more so-called “wet” metallization methods, electrolytic or chemical (non-electrolytic), from one or more suitable metallization solution(s), generally easier and less expensive to implement, in particular in an industrial manufacturing context.

Therefore, in an advantageous variant, metallization step D is carried out by (chemical) non-electrolytic deposition from one or more metallization solution(s) (or “redox solution(s)”, advantageously containing at least one metal in metal cation form (i.e. metal in cationic form, forming an oxidant) and at least one reducing agent adapted to transform the metal cation into metal. Said at least one metal cation can advantageously be obtained by liquid phase dissolution of at least one corresponding metal salt.

According to a first embodiment of this non-electrolytic variant, the above-mentioned non-electrolytic deposition (or “metallization”) is more specifically carried out by spaying the metallization solution(s) in the form of one or more aerosol(s). In this case, the method according to the invention possibly comprises, before said metallization step D, at least one of the following additional steps:
a treatment step P for increasing the surface energy of the substrate, knowing that if the method includes an activation step H, wherein such a treatment step P for increasing the surface energy of the substrate can possibly be provided before said activation step H;
a step Q of wetting the substrate surface;
a step R of rinsing the substrate surface.

The treatment step P for increasing the surface energy of the substrate may possibly be comparable to a step F of preparing the substrate surface.

This embodiment using spraying of aerosol(s) is particularly interesting in that, in addition to the excellent properties of the metal deposit that can be formed that way, it allows a simple and fast metallization of substrates of any size, and in particular substrates of large sizes. Moreover, it is particularly well suited to the case where metallization step D is carried out after thermoforming step C, and where the surface to be metallized is thus not flat but on the contrary deformed. Beside, this embodiment enables to obtain in particularly simple way a metal deposit whose thickness is variable depending on the extent of said metal deposit, as contemplated hereinabove. Moreover, this embodiment using spraying of aerosol(s) advantageously enables to form in a simple and efficient way a metal deposit of solid, dense metal (and therefore substantially free of porosity, unlike a porous metal deposit which would be formed from an aggregate of metal particles), which is particularly interesting in particular when it is desired to obtain a metal pattern with excellent electric properties.

According to a second embodiment of this non-electrolytic variant, the above-mentioned non-electrolytic deposition is an auto-catalytic (or “electroless”) chemical deposition (or “metallization”) carried out by immersing the substrate into one or more metallization solution(s) possibly comprising, in addition to one or more metal cation(s) and one or more reducing agent(s), one or more complexing agent(s), one or more stabilising agent(s), and any other additives (surfactants, etc.). In this case, the method then advantageously comprises a step H of activating the substrate surface previously to metallization step D, and possibly before said activation step H, at least one of the following steps, preferably in the following order:
satin-finishing step S, preferably implemented between step B of forming the temporary masking coating and activation step H;
step T of rinsing the substrate surface, in case of implementation of such a satin-finishing step S.

As another wet variant, metallization step D may possibly be carried out by electrolytic deposition (or “electrodeposition” or “galvanostegy”, also known as electroplating). Such an electrolytic deposition (or “metallization”) is based on a redox reaction using an electric current, based on a metallization solution typically containing at least one metal in cationic form in an aqueous medium. An electric current is applied between the substrate that is to be metallized and a counter-electrode. The metal cation is then reduced at the substrate surface to form a metal deposit. However, such a method of metallization by electrolytic deposition is less preferable than the two previous ones insofar as it is conceivable only in the single case in which the thermoformable material of the substrate is (electro) conductive, which thus strongly limits the choice in thermoformable material, excluding in particular most of the thermoformable polymer materials.

Possibly, metallization step D can be carried out, on the one hand, according to the first embodiment of the above-mentioned non-electrolytic metallization variant (i.e. spraying of aerosol(s)) and possible, on the other hand, according to the above-mentioned second embodiment of the non-electrolytic metallization variant (i.e. by immersion) and/or according to the above-mentioned electrolytic deposition variant.

As is clear from the above, step E of eliminating the temporary masking coating (hereinafter abbreviated to “step E”) aims to remove the temporary masking coating present on the substrate surface.

As such, step E may be carried out:
either before metallization step D, in the case in particular where the method comprises a step H of activating the substrate surface previously to metallization step D and where the temporary masking coating is intended to enable a selective activation of the substrate surface;
or after metallization step D;
or, preferentially, during metallization step D, or partly during metallization step D and partly after metallization step D, or partly before metallization step D, partly during metallization step D and partly after metallization step D.

Carrying out step E at least partially concurrently with metallization step D, as preferentially proposed hereinafter, advantageously contributes to accelerate and simplify the implementation of the method according to the invention, by limiting the number of successive steps required.

Advantageously, step E of eliminating the temporary masking coating is carried out at least partially by chemical, non-mechanical means, in order to eliminate said temporary masking coating in a simple and clean way from the substrate surface, in particular in the case where said step E is carried out posteriorly to thermoforming step C, by limiting the risk of degrading the thinness and precision of the metal pattern(s) to be obtained.

Therefore, step E of eliminating the temporary masking coating advantageously comprises at least one operation of dissolving (at least partially) the temporary masking coating using at least one solvent implemented in the method. Possibly, step E may advantageously essentially consist in dissolving (at least partially) the temporary masking coating using at least one solvent implemented in the method. Herein “dissolving using at least one solvent” means total or partial disintegration, decomposition or loss of cohesion of the temporary masking coating, under the action of a particular fluid (preferably, a liquid) chosen for its specific chemically aggressive nature relative to the temporary masking coating, likely to allow it to be disintegrated, detached and evacuated from the substrate surface. It may thus be a mechanism of dissolution in a solvent in the strict chemical sense, but not necessarily. Preferably, said temporary masking coating is alkali-soluble (or at least alkali-sensitive) so that it can be preferentially dissolved by an alkaline solvent implemented in the method.

Step E can possibly comprise, previously to said temporary masking coating dissolution operation, an exposure operation under actinic radiation (e.g., under UV-light) and/or a heat-treatment operation on the temporary masking coating, in order to weaken the temporary masking coating and/or to facilitate the latter dissolution thereof. Step E may possibly comprise, after such a dissolution operation, an operation consisting in particular in facilitating the evacuation of the dissolved temporary masking coating and/or of any debris that is not completely dissolved from the latter, by carrying it along in liquid phase and/or by mechanically carrying it along using a gas (preferably, air).

In the case mentioned hereinabove in which step E is carried out in metallization step D, or partly in metallization step D and partly after metallization step D, or partly before metallization step D, partly during metallization step D and partly after metallization step D, said solvent for eliminating the temporary masking coating by dissolution is preferentially at least contained in the metallization solution (or one of the metallization solutions) implemented in step D. It is therefore an operation of dissolving the temporary masking coating with at least one solvent implemented in step D. The duration of formation of the metal deposit in said metallization step D is then preferably chosen less than or equal to the time required for dissolving the temporary masking coating under the action of said solvent.

As a complement or as an alternative, the method may comprise a step I of rinsing the metallized substrate surface and the solvent for eliminating the temporary masking coating by dissolution may be contained in a rinsing liquid implemented in said step I.

Nevertheless, it remains possible, although less preferentially, that step E can be carried out by non-chemical means, and for example by laser ablation, using a pressurised gas jet, or by any known suitable mechanical means.

This being exposed, some aspects of the above-mentioned steps will now be described in detail.

### —Step a of Providing a Flat Substrate Made of a Thermoformable Material—

Although it can be contemplated to implement a flat substrate made of glass (mineral) or metal, it is however preferable that the flat substrate is made of a thermoformable polymer material (thermoplastic material), filled or not, or a composite polymer-matrix thermoformable material. Indeed, the polymer or polymer-matrix thermoformable materials are in particular generally easier to implement, due to a softening temperature far less than that of glass or most of the metals. The conceivable thermoformable polymer materials include, by way of non-limiting examples, polystyrene (PS), “impact” polystyrene (SB/HIPS), polyethylene (PE), polypropylene (PP), polycarbonate (PC), acrylonitrile-butadiene-styrene (ABS), polyvinyl chloride (PVC), polymethyl methacrylate (PMMA), or thermoplastic polyesters, such as polylactic acid (PLA), polyethylene terephthalate (PET) and glycolised polyethylene terephthalate (PETG). In the case where the flat substrate is a composite polymer-matrix thermoformable material, wherein the polymers of the polymer matrix can be chosen, for example, among the thermoformable polymer materials listed hereinabove.

More generally, the thermoformable material of the flat substrate can be a single material or on the contrary a composite material. The flat substrate can be single-layer or possibly multi-layer.

Advantageously, said flat substrate can be a film, a sheet or a plate of thermoformable polymer material or a composite polymer-matrix thermoformable material, of thickness between 8 μm and 15 mm, and still preferably between 25 μm and 10 mm, which makes it easier to handle and thermoform later.

According to the chosen material and thickness, the flat substrate can be substantially rigid, or on the contrary flexible. It is however preferable in practice, in order in particular to facilitate an industrial implementation of the method, that the flat substrate is flexible, i.e. it can advantageously be bent or folded by human force alone, without breaking, deforming or irreversibly deteriorating. The flat substrate can thus be, for example, advantageously provided in continuous from a coil of wound substrate, then wound again into a coil at the end of step B of forming the temporary masking coating or at the end of metallization step D, in the case (variant V2) in which the latter is carried out before thermoforming step C (so-called “roll-to-roll”/“R2R” method). In contrast, “rigid substrate” means a substrate that cannot be bent or folded by human force alone without breaking or irreversibly degrading.

### —Step F of Preparing the Substrate Surface—

As introduced hereinabove, the method may include one (or more) step(s) F of preparing the substrate surface, which aim to modify certain properties of the substrate surface for the implementation of one or more latter step(s) of the method. It may be one (or more) step(s) of preparing the surface of the flat substrate, thus carried out before thermoforming step D, and/or one (or more) step(s) of preparing the surface of the thermoformed substrate, thus carried out after thermoforming step C.

Moreover, such a step F may be carried out before or after step B of forming the temporary masking coating. In certain cases, preparing the surface of the flat substrate before forming the temporary masking coating allows the temporary masking coating not to undergo physico-chemical modifications, that would lead to a too high adhesion of the latter to the surface of the flat substrate, likely to make subsequent elimination of the temporary masking coating more difficult. In other cases, preparing the surface of the flat substrate may be carried out after forming the temporary masking coating, so as, on the contrary, to reinforce the cohesion, adhesion, of the temporary masking coating, and possibly slow down the elimination thereof.

Step F may comprise an operation of cleaning and/or degreasing the substrate surface, by means of any known and suitable product. In addition to or instead of such a cleaning/degreasing operation, step F may comprise an operation of depositing on the substrate surface a varnish, possibly coloured/pigmented, e.g. a UV cross-linking varnish applied by spraying, by any known and suitable means such as a compressed air spray gun (e.g., a High Volume Low Pressure (HVLP) spray gun).

Optionally, step F may comprise at least, or correspond to, a treatment for increasing the surface energy of the substrate surface (step P).

### —Step B of Forming the Temporary Masking Coating—

The practical arrangements for carrying out step B may depend in particular on the nature of the thermoformable material of the flat substrate, on the desired accuracy for defining the unmasked area(s), as well as potentially, in the case in particular of the above-mentioned sub-variant V1a, the conditions of thermoforming step C (in terms in particular of thermoforming and deformation ratio) to which the flat substrate and the temporary masking coating are subsequently to be subjected in thermoforming step C.

Said step B of forming the temporary masking coating is preferentially carried out by
selectively depositing a layer of a liquid or paste masking composition on the flat substrate surface, by any known and suitable technique of application, and for example screen printing, pad printing, flexography, rotogravure and/or direct printing (e.g. drip or “inkjet”),
possibly followed by drying and/or curing the so-deposited layer of masking composition.

According to the formulation of the masking composition chosen, the drying and/or curing of the latter may comprise a drying/desolvation operation, possibly under the effect of a heat input, or polymerization/cross-linking of the deposited masking composition under the effect of a heat input and/or under the action of actinic radiation (e.g., by exposure to ultraviolet (UV) light). Such a drying and/or curing of the deposited masking composition layer is particularly advantageous depending on the fluidity of the masking composition, in order to avoid an uncontrolled spreading of the masking composition likely to harm the shape definition of the unmasked area(s).

Alternatively, albeit in a more complex and therefore less preferential way, step B may be carried out by
depositing (in a non-selective way) said liquid or paste masking composition on the flat substrate surface, for example by soaking, spraying or any other known and suitable non-selective deposition technique,
possibly followed by drying and/or curing the so-deposited masking composition layer,
followed by selectively removing the formed temporary masking coating to locally create one (or more) unmasked area(s) at the flat substrate surface.

Possibly, said masking composition is deposited at the surface of the flat substrate in step B according to a two-dimensional masking pattern previously-defined in a step G as described hereinafter.

The masking composition may be chosen substantially colourless, or on the contrary coloured/pigmented. A masking composition containing a dye/pigment makes it possible, as the case may be, to more easily visualize the temporary protective coating formed at the surface of the flat substrate, which may be practical in certain cases.

Preferably, step B is carried out so that the temporary masking coating has, at the end of step B of forming the latter (and hence, as the case may be, after drying and/or curing of the deposited masking composition layer), a thickness of between 100 nm and 50 μm, preferably between 500 nm and 20 μm, and still preferably between 1 μm and 10 μm. Such a thickness makes it possible to obtain a sufficient barrier effect at the surface of the substrate areas that are not intended to subsequently carry the metal pattern(s). Moreover, such a thickness advantageously contributes to the capacity of the temporary masking coating to undergo thermoforming step C without significant damage, as the case may be (variant V1a). In another variant, step B is carried out in such a way that, at the end of step B, the thickness of the temporary masking coating is substantially constant along the whole extend of the temporary masking coating, i.e. the thickness of the latter is substantially identically at any point of said temporary masking coating. As another variant, step B is carried out in such a way that, at the end of step B, the thickness of the temporary masking coating is variable over the extent of the latter (while remaining preferentially in the above-mentioned ranges of values), i.e. the temporary masking coating has a least a first portion and a second portion, distinct from each other, wherein the thickness of the first portion is different from the thickness of the second portion. Such a thickness difference of the temporary masking coating, preferably in the ranges of values indicated hereinabove, can be interesting in particular in the case of variant V1, to adapt locally the thickness of the temporary masking coating to the deformation amplitude to which a given area of the substrate (masked) is to be subjected during thermoforming step C.

It is to be noted that, as the temporary masking coating forming step B is carried out on the (flat) substrate before thermoforming step C, the temporary masking coating thus does not form at the end of step B, or at least not necessarily, an exact negative of the metal pattern(s) that is to be obtained in fine at the surface of the thermoformed substrate. Indeed, according to the above-described sub-variant Via, the temporary masking coating itself undergoes a deformation during step C, so that this is the deformed temporary masking coating, obtained at the end of step C, which then advantageously corresponds to the negative of the metal pattern(s) to be obtained. According to the variant V2, the temporary masking coating can be present or not on the substrate surface when the thermoforming step C is carried out. In the preferential case in which Step E of eliminating the temporary masking coating is carried out before step C, the surface of the flat substrate is thus provided with one (or more) “raw” metal pattern(s) that will undergo a deformation during thermoforming step C in order to generate the desired metal pattern(s). Therefore, the temporary masking coating corresponds in this case to the negative of said “raw” metal pattern(s).

As mentioned hereinabove, in the case of the sub-variant Via of variant V1, the temporary masking coating is advantageously thermoformable and designed, in particular in terms of capacity of elongation/deformation without breaking and temperature resistance, to be capable of undergoing the conditions for carrying out step C of thermoforming the flat substrate, without significant degradation of its function of masking the surface of the latter. Typically, the temporary masking coating is advantageously designed so as to have, in particular at the forming temperature chosen for thermoforming step C, an elongation/deformation ratio without breaking at least equal to the deformation ratio that is desired to be imparted to the flat substrate in the thermoforming step.

Such a particular design can typically be achieved by making an appropriate choice in terms of formulation of the masking composition, it being understood that the exact formulation of the masking composition can depend in practice on a certain number of factors such as, in particular, the mode of application of the masking composition onto the substrate, the nature of the thermoformable material of the substrate, the forming temperature at which the thermoforming step C is carried out, the thickness of the temperature masking coating to be formed, the deformation ratio that is desired to be imparted to the flat substrate and to the temporary masking coating in thermoforming step C, etc. For example, such an ability of the temporary masking coating to support the conditions for carrying out step C of thermoforming the flat substrate can be imparted to it by choosing, in the formulation of the masking composition, a particular polymeric organic binder able to form a polymeric organic matrix having the desired capabilities of elongation/deformation without breaking and temperature resistance.

The preferentially dissolvable (or sensitive) nature of the temporary masking coating to a solvent implemented in the method, and more preferentially at least to a solvent contained in the metallization solution or one of the metallization solutions implemented in step D, can be imparted to the temporary masking coating by making a choice as regards the masking composition formulation, and by choosing for example a component, such as in particular a polymeric organic binder intended to form a polymeric organic matrix, that can be dissolved by the solvent in question, or at least less sensitive to the latter.

For example, the masking composition implemented in step B can comprise all or part of the following components (it being understood that the masking composition content of each of the components may depend in particular on the mode of application chosen for said masking composition, as well as its potential mode of drying/curing):
a vehicle component, that can represent between 20% and 70% of the total weight of the masking composition. The vehicle component may comprise an organic or aqueous solvent, a monomer, an oligomer or a mixture of those compounds. It has for particularity to solubilize or suspend the rest of the components described hereinafter. The vehicle component helps in the viscosity and the rheological properties of the masking composition, thus facilitating the application thereof. It is intended to be evaporated in the case of a masking composition to be thermally cured and/or to be cross-linked in the case of a UV cross-linking masking composition, for example:
a binder component, that can represent between 30% and 70% of the total weight of the masking composition. It is advantageously intended to form an organic polymer matrix that may be acrylic, polyester, vinyl, styrenic or polyamide in the case of a heat-drying masking composition. In the case of a UV-cross-linkable masking composition, the binder component can be a mixture of acrylate, cationic or anionic monomers and oligomers as well as the polymers mentioned above. The binder component can further possibly play the role of a vehicle. The binder component imparts to the temporary masking coating its main properties, in particular its adherence to the substrate, its resistance to friction, its potential sensitivity to a solvent implemented in the method (e.g., alkali-sensitivity) and its potential capability to support thermoforming step C and to be thermodeformed without breaking during this latter step;
a solid, organic or inorganic, component, that can represent between 1% and 50% of the total weight of the masking composition. It can correspond to mineral or organic, possibly fibrous, filler. It may impart, or contribute to impart, to the masking composition and/or the temporary masking coating a colour, particular rheological properties and resistance to friction;
one or more additive(s), that can represent between 0.01% and 10% of the total weight of the formulation. It may be one or more rheology additives, wetting agents, antifoams, dispersants, surfactants, stabilisers or colourants. Among other things, these additives enable the rheology, applicability and wettability of the masking composition on the substrate to be corrected, and the drying or curing of the masking composition to be accelerated or decelerated, to better disperse and stabilise the solid component, to colour the masking composition, or to improve certain properties of the temporary masking coating, such as for example its resistance or gloss;
possibly, one or more photo-initiators, that can represent between 5% and 15% of the total weight of the masking composition. In the case of a UV-curable masking composition, they enable the monomers and oligomers to cross-linked. They may be of radical, cationic or anionic nature.

By way of non-limiting examples, vehicle components include: water, butanol, methoxypropanol, ethyl acetate, butyl acetate, cyclohexane, 2-butoxyethanol acetate, 2-methoxy-1-methylethyl acetate, propylene carbonate, isopropyl myristate, diethylene glycol monoethyl ether acetate, glycerol, hexane, methylcyclohexane, or else, among the monomers: PETIA, HDDA, IBOA, TMPTA, TPGDA, HEMA, etc. By way of non-limiting examples, binder components include: a copolymer of vinyl acetate and vinyl chloride, an acrylic resin, polyvinyl alcohol, polyvinylpyrrolidone, a polyurethane, an aliphatic urethane acrylate, a polyester acrylate, a polyester, etc. By way of non-limiting examples, solid components include: silica, barium carbonate, barium sulphate, aluminium hydroxide, wax, etc.

### —Step G of Defining a Two-Dimensional Masking Pattern—

It may be important, in particular in the case where said at least one metal pattern is intended to play a functional role, and in particular for radio or electronic applications, to provide a perfect control of the shape of the metal pattern obtained at the surface of the thermoformed substrate. As such, the method according to the invention may advantageously comprise, before step B, a step G of defining a two-dimensional masking pattern, along which the temporary masking coating is then formed at the surface of the flat substrate in said step B of forming the temporary masking coating, by modelling a deformation of the flat substrate and, as the case may be, of temporary masking coating, during thermoforming step C and representing (or modelling) said at least one metal pattern to be obtained. In other words, a definition of a two-dimensional masking pattern is made by “inverse anamorphosis”, so that this two-dimensional masking pattern, along which the temporary masking coating is formed on the flat substrate surface in step B, makes it possible to obtain the desired metal pattern(s) by anticipating and compensating for the effects of the deformation generated by thermoforming step C. The step of defining such a two-dimensional masking pattern can be carried out using commercially available computer software, such as, for example, the software T-SIM® by SIMCON (formerly CADFLOW), the software PAM-FORM™ by ESI GROUP, the software solution ANAMAP™ by KALLISTO or the software Thermo 3D™ by QUADRAXIS.

### —Step H of Activating the Substrate Surface—

According to the nature of the substrate, the nature of the metal deposit to be formed, and according to the metallization method(s) used for carrying out metallization step D, a previous step of activating the substrate surface may be necessary to allow, or at least facilitate, the formation of the metal deposit onto the substrate surface.

In the case where metallization step D is carried out by non-electrolytic deposition by spraying one (or more) metallization solution(s) in the form of aerosol(s), such an activation (or at least “sensitization”) step H may be necessary for depositing certain metals. It aims in particular to accelerate the redox reaction involved in step D. During step H, the substrate surface is put into contact with at least one chemical sensitization species, which is adsorbed on the substrate surface and which thereafter accelerates the metallization reaction.

Preferably, the activation step H is carried out after step B of forming the temporary masking coating and before step E of eliminating the latter, so that the one or more chemical sensitization species are thus adsorbed both on the temporary masking coating and on the area(s) not masked, i.e. not covered, by the latter.

In practice, step H is preferentially made by spraying onto the substrate surface at least one sensitizing solution, and that by any known and suitable means, such as for example using a compressed air paint gun (e.g., High Volume Low Pressure (HVLP) spray gun). Alternatively, step H could be carried out by immersion of the substrate into at least one sensitizing solution.

For example, a first sensitizing solution based on stannous chloride (SnCl₂) or SnSO₄/H₂SO₄/quinol/alcohol, is applied by spraying or immersion. A palladium or silver-based solution, capable of reacting with ions Sn²⁺ to form nucleation centres on the substrate surface, or a PdSn colloidal solution, formed ex situ is then deposited in the same way. For more precision, reference can be made for example to “Metal Finishing Guidebook and Directory Issue”, 1996 Metal Finishing publication, pages 354, 356 and 357. H. Narcus; to “Metallizing of Plastics”, Reinhold Publishing Corporation, 1960, Chapter 2, page 21. F. Lowenheim; or to “Modern electroplating”, John Wiley & Sons publication, 1974, Chapter 28, page 636. Advantageously, the substrate surface sensitization is implemented using a stannous chloride-based sensitizing solution, for example in accordance with the mode of implementation described in document FR-2 763 962 B1. In this case, a rinsing step using a rinsing liquid as described hereinafter is carried out immediately after the sensitization, without intermediate step. As a variant, the substrate surface activation is implemented using a sensitizing solution, in particular palladium chloride, for example in accordance with the mode of implementation described in document FR-2 763 962 B1. In this case, a rinsing step using a rinsing liquid as described in the examples hereinafter is carried out immediately after the activation step H, without intermediate step.

In the case where metallization step D is carried out by auto-catalytic (“electroless”) chemical deposition by immersion into one (or more) metallization solution(s), such an activation step H, that advantageously aims to accelerate the catalytic redox reaction involved in step D, is generally indispensable. It consists in depositing onto the surface of the masked substrate, an electroless chemical metallization catalyst, for example a Sn/Pd type catalyst.

Preferably, activation step H is carried out after step B of forming the temporary masking coating and before step E of eliminating the latter, so that the catalyst is adsorbed both on the temporary masking coating and on the area(s), not masked, i.e. not covered, by the latter.

Step H is preferably preceded by a satin-finishing step S followed by a rinsing step T. Step S corresponds to a treatment for increasing the surface energy of the substrate and/or for increasing the roughness of the substrate, which may be of the type described hereinafter for step P. In the case of an auto-catalytic chemical deposition, the satin-finish is, preferably, carried out by physical treatment (corona discharge, plasma treatment, etc.) or chemical treatment (e.g. a sulpho-chromic or other treatment) in order to give sufficient adhesion to the metal deposit to be formed. Rinsing step T advantageously corresponds to a rinsing of the type described hereinafter for step R.

### —Step C of Thermoforming the Flat Substrate—

Step C of thermoforming the flat substrate can be advantageously carried out by any known thermoforming means and technique, obviously adapted to the substrate characteristics (nature of the thermoformable material, flat substrate thickness, etc.) and, as the case may be, to the intrinsic characteristics of the temporary masking coating and/or to the intrinsic characteristics of the metal deposition or the metal pattern(s), potentially present at the surface of the flat substrate to be thermoformed.

Typically, step C is carried out by heating the flat substrate advantageously homogeneously, by conduction and/or by convection and/or by radiation, until the thermoformable material of the flat substrate is heated to a forming temperature sufficient to render the flat substrate malleable. The forming temperature in question can obviously vary as a function of the thermoformable material chosen. For a thermoformable polymer material, the forming temperature is typically chosen at least equal to a glass transition temperature of the considered material, and nevertheless advantageously below the melting temperature of the material in question. Once made malleable, the flat substrate is pressed against a male (“positive”) or female (“negative”) mould (or counter-form), advantageously with vacuum and/or pressure suction, so that the flat substrate deforms and conforms the mould shape. The deformed substrate is then cooled so that the thermoformable material cures and keeps the shape imparted by the mould, and the deformed substrate is subsequently extracted from the mould.

### —Metallization Step D—

As previously introduced, metallization step D can be carried out after thermoforming step C (variant V1) or on the contrary before thermoforming step C (variant V2).

### Non-Electrolytic Deposition by Projection in the Form of Aerosol(s)

Step P of treatment for increasing the surface energy of the substrate, step Q of wetting the substrate surface and step R of rinsing the substrate surface, which may possibly precede activation step H or metallization step D, are described hereinafter, as a preamble to a description of metallization step D according the embodiment contemplated hereinabove in which the metallization is carried out by non-electrolytic (chemical) deposition by projection of one (or more) metallization solution(s) in the form of aerosol(s). In the case where step D is carried out after thermoforming step C (variant V1), said steps P, Q and R are preferentially carried out after said step C.

Step P of treatment for increasing the energy of the substrate surface can be carried out:
by physical treatment, preferably chosen among the following physical treatments: flaming, plasma treatment, corona treatment, roughness increase (by sandblasting, shot-blasting, etc.) and combinations thereof, and/or
by chemical treatment, preferably chosen among the following chemical treatments: application of a silane-based solution, depassivation of the surface using one or more acid solution(s), rare earth oxide polishing, fluorination, acid or alkaline chemical attack to create a microroughness, and the combinations thereof.

More preferentially, the physical treatment is a flaming and/or plasma treatment, in the case in particular in which the substrate, flexible or rigid, is made of a thermoformable polymer material or a composite polymer-matrix thermoformable material. The flaming operation consists, for example, in passing the substrate to be metallized under a flame whose temperature is for example between 1,200° C. and 1,700° C. The flaming duration is generally of 4 to 50 seconds. The flame is preferably obtained by combustion of a fuel, such as propane for example, in the presence of an oxidant such as oxygen. The plasma treatment corresponds, for example, to the passage of the substrate to be metallized in a plasma torch, for example those which are commercialized by ACXYS® or PLASMATREAT®. More preferentially, the chemical treatment is a fluorination treatment, in the case in which the substrate, flexible or rigid, is made of a thermoformable polymer material or a composite polymer-matrix thermoformable material. Fluorination corresponds for example to putting the substrate to be metallized into contact, within an enclosure under reduced pressure, with a gaseous solution based on inert gas (argon) containing a fluorine additive. Such fluorination may be carried out, for example, with equipment of the type marketed by AIR LIQUIDE®.

In any case, these physical and/or chemical treatments for increasing the surface energy of the substrate must advantageously be carried out so that the surface energy of the substrate is, at the end of step P, higher than or equal to 50 or to 55 dynes, preferably higher than or equal to 60 or 65 dynes, and even more preferentially higher than or equal to 70 dynes. Below these values, the substrate wetting could reveal insufficient and the metal deposit obtained after metallization could have unsatisfactory adhesion, gloss and reflectivity characteristics. The surface energy value may be measured for example by known techniques of the person skilled in the art consisting in applying on the substrate, using a brush or felt-tip, a specific solution and measuring the shrinkage time of the solution thus applied.

Wetting step Q typically consists in coating the substrate surface with a liquid film, for example by a spraying or vaporisation/condensation of a wetting liquid, to favour the spreading of the metallization solution(s) (“redox solution(s)”). The wetting liquid is preferably chosen in the following group: deionised or non-deionised water, optionally with the addition of one or more anionic, cationic or neutral surfactant(s), an alcoholic solution comprising one or more alcohol(s) (e.g., isopropanol, ethanol and mixtures thereof), and mixtures thereof. For example, deionised water added with an anionic surfactant and ethanol can be chosen as the wetting solution. In a wetting variant in which the wetting liquid is transformed into vapour that is sprayed onto the substrate on which the vapour is condensed, it is preferable that the liquid is essentially aqueous for evident reasons of industrial convenience. The wetting duration depends on the substrate surface considered and the wetting liquid spraying or vaporisation/condensation rate. Wetting step Q can possibly be substituted for activation step H.

Advantageously, rinsing step R, like the other rinsing steps in the method, unlike step I or step T, consists in putting in contact all or part of the substrate surface with one or more rinsing liquid(s), preferably demineralized water, by spraying an aerosol of the rinsing liquid(s).

Step D of non-electrolytic (chemical) deposition metallization by spraying one (or more) metallization solution(s) in the form of aerosol(s) advantageously relates to the method described in documents FR-2 763 962 B1, EP-2 326 747 B1 or EP-2 318 564 B1.

Metallization step D is advantageously carried out (at least) by non-electrolytic deposition, using:
either only one metallization solution containing said at least one metal in metal cation form and said at least one reducer adapted to transform the metal cation into metal,
or two distinct solutions: the first solution (“oxidizing solution”) containing at least one metal in metal cation form (oxidizing agent(s)) and the second solution (“reducing solution”) containing one or more reducing agent(s),
or a plurality of distinct solutions, each able to contain either at least one metal in metal cation form (oxidizing agent(s)), or one or more reducing agent(s), provided that at least one of the solutions (“oxidizing solution”) contains at least one metal in metal cation form and that at least another one of the solutions (“reducing solution”) contains one or more reducing agent(s).

The reducing agent is advantageously chosen strong enough to reduce the metal cation into a metal, i.e. the chosen standard redox potential of the oxidizing/reducing pair of the reducing agent is less than that of the oxidizing/reducing pair of the oxidizing agent (Gamma rule). Such a non-electrolytic variant is in particular advantageous in that it allows the formation, on the surface of a substrate that is indifferently conductive or not, of a solid metal deposit, as contemplated hereinabove, moreover with a thickness advantageously included in the above-mentioned ranges of values.

During metallization step D, the metallization solution(s) are sprayed in the form of one (or more) aerosol(s) onto the masked substrate, and in particular at least onto the unmasked area(s) of the latter. As used herein, “aerosol” means a set of fine particles of the metallization solution(s) in suspension in a gaseous medium (e.g. air). It can therefore advantageously be a mist of droplets smaller than 100 μm, preferably smaller than 60 μm, and more preferentially also from 0.1 μm to 50 μm, obtained by nebulization and/or atomization of the metallization solution(s).

Advantageously, the metallization solution(s) (“redox solution(s)”) can be obtained from solutions, advantageously aqueous, of one or more oxidizing metal cation(s) (typically obtained by dissolution of one or more corresponding metal salt(s)) and one or more reducing component(s), preferably by dilution of concentrated stock solutions, the diluent being preferably demineralized water. According to the nature of the metal deposit to be formed, the spraying of the metal solution(s) can be carried out continuously, i.e. all at once, or discontinuously by alternating spraying phases and relaxation times. For example, for a silver-based metal deposit, the spraying will be preferentially carried out continuously. For example, for a nickel-based metal deposit, the spraying will be preferentially carried out discontinuously by alternating spraying phases and relaxation times. According to the desired metal deposit thickness, the spraying duration may advantageously vary between 0.5 s and 200 s, preferably between 1 s and 50 s, and even more preferentially between 2 s and 30 s for a substrate surface area to be metallized of 1 dm². A modulation of the spraying cone can be used to spray the metallisation solution(s) onto a wider or narrower area of the substrate. By modulating the spraying duration and/or the quantity of metallization solution(s) sprayed locally, it is possible to obtain a gradient of metal deposition thickness, as mentioned hereinabove.

The spraying of the metallization solution(s) can be carried out using any suitable spraying means, preferably using one or more compressed air spray gun(s), such as for example one or more High Volume Low Pressure (HVLP) spray gun(s). Advantageously, the spraying means and the substrate can be set in relative motion (translation and/or rotation), in order to enable an in-line metallization and/or to ensure a good spraying onto all the areas to be metallized on the substrate in particular in the case where the latter has been thermoformed previously to the metallization step D.

According to a first spraying method, one or more metal cation solution(s) (“oxidizing solution(s)”) and one or more reducing agent solution(s) (“reducing solution(s)”) are sprayed simultaneous and continuously, in the form of one or more aerosol(s), onto the surface to be treated. In this case, the mixture between the oxidizing solution and the reducing solution may be performed just before the formation of the aerosol or also by merging of an aerosol produced from the oxidizing solution and an aerosol produced from the reducing solution, preferably before they come into contact with the substrate surface to be metallized. According to the second spraying method, one or more metal cation solution(s) (“oxidizing solution(s)”) then one or more reducing agent solution(s) (“reducing solution(s)”) are sprayed successively, using one or more aerosol(s). In other words, the spraying of the redox solution is carried out through separate spraying(s) of one or more solution(s) of one or more metal oxidizing agent(s) and one or more solution(s) of one or more reducing agent(s). This second possibility corresponds to an alternate spraying of the reducing solution(s) and the metal cation solution(s). Within the framework of the second projection method, the association of several oxidising metal cations to form a multilayer of different metals or alloys, is such that the different metal cations are, preferably, naturally sprayed separately from the reducing agent but also separately from each other and successively.

According to a third spraying method, a metallization solution, made metastable, containing a mixture of said at least one metal in metal cation form (“oxidizing agent(s)”) and said at least one reducing agent are sprayed in aerosol form, then after spraying onto the substrate surface, the metallization solution is activated so as to trigger the transformation of the metallization cation(s) into metal, preferably by contact with a primer, advantageously added using one or more aerosol(s), before, during and after the spraying of the metallization solution. The priming or activation of the redox reaction is then perhaps obtained by any suitable physical (temperature, UV, etc.) or chemical means.

Water appears as the most suitable solvent, although organic solvents may also be used, for preparing the metallization solution(s) to be sprayed in the form of aerosol(s).

The concentration(s) in metal salt(s) of the oxidizing solution(s) to be sprayed are preferentially of between 0.1 g/l and 100 g/l and still preferably of between 1 g/l and 60 g/l. As the case may be, the concentration(s) in metal salt(s) of the stock solution(s) are preferably of between 0.5 g/l and 500 g/l, or the dilution factor of the stock solution(s) is preferentially of between 5 and 5,000. Advantageously, the metal salts are chosen among silver nitrate, nickel sulphate, copper sulphate, tin chloride, aurochloric acid, iron chloride, cobalt chloride, and mixtures thereof.

The selection of the reducing agent(s) is preferably made among the following components: borohydrides, dimethylaminoborane, hydrazine, sodium hypophosphite, formaldehyde, lithium aluminohydride, reducing sugars such as glucose derivatives or sodium erythorbate, and mixtures thereof. The selection of the reducing agent must take account of the pH and the properties required for the metal deposit. These routine adjustments are within the reach of the person skilled in the art. The concentration(s) in metal salt(s) of the reducing solution(s) to be sprayed are preferentially of between 0.1 g/l and 100 g/l and still preferably of between 1 g/l and 60 g/l. As the case may be, the concentration(s) in reducing agent(s) of the stock solution(s) are preferably of between 0.5 g/l and 250 g/l, or the dilution factor of the stock solution(s) is preferentially of between 5 and 2,500.

Optionally, additional particles, as contemplated hereinabove, may be incorporated into at least one of the metallization solutions to be projected onto the substrate during the metallization step D. The additional particles are thus advantageously trapped in the metal deposit formed on the substrate surface.

As indicated hereinabove, such a method of metallization by spraying aerosol(s) is particularly interesting in that it enables in particular a simple and quick metallization of substrates of any size, and in particular substrates of great size, and in that it is particularly well suited to the case where metallization step D is carried out after thermoforming step C (variant V1), and where the surface to be metallized is thus not flat but deformed.

Moreover, such a method of metallization by spraying aerosol(s) makes it possible, in the context of the invention, to obtain a metal deposit, possibly multilayer, provided with excellent properties in terms in particular of adherence to the substrate, thickness homogeneity and state of surface (very low roughness). It is therefore advantageously possible in particular to obtain that way one or more metal pattern(s) having excellent properties in terms of electrical conductivity. Moreover, such a method of metallization by spraying aerosol(s) enables a particularly fine control of the thickness of the metal deposit formed, which can therefore in particular be transparent or opaque, depending on the application.

### Non-Electrolytic Deposition by Immersion

In accordance with what has been described hereinabove, according to the embodiment in which the metallization of the substrate is carried out by auto-catalytic (or “electroless”) chemical deposition by immersing the substrate into one (or more) metallization solution(s), the metallization step D can advantageously be preceded by a step H of activating the substrate, and possibly preceded, before said activation step H, of at least one of the following steps, preferably in the following order:
satin-finishing step S, preferably implemented between step B of forming the temporary masking coating and activation step H;
step T of rinsing the substrate surface, in case of implementation of such a satin-finishing step S.

Advantageously, the satin-finishing step S is a treatment step for increasing the surface energy of the substrate as described hereinabove in relation to the non-electrolytic metallization by spraying aerosols (Step P). The same applies to rinsing step T.

As introduced hereinabove, the metallization step D is, in this particular embodiment, typically carried out by immersion of the substrate into a bath (“electroless” bath) of a metallization solution, possibly comprising, in addition to one or more metal cation(s) and one or more reducing agent(s), one or more complexing agent(s), one or more stabilising agent(s), and any other additives (surfactants, etc.). Typically, at step D, the metal deposit is formed on all the areas of the substrate on which a catalyst has previously been deposited during activation step H.

Insofar as activation step H is preferentially carried out after step B of forming the temporary masking coating and before step E of eliminating the latter, the substrate area(s) covered with temporary masking coating are thus not catalysed and cannot therefore be the site of metal deposit formation.

Preferably, metallization step D is here carried out after step E of eliminating of the temporary masking coating. Indeed, in the hypothesis in which, on the contrary, the metallization step D would be carried out before step E, it would be advantageous to provide that the temporary masking coating be designed in such a way that the catalyst cannot be adsorbed at the surface of the latter, and that said temporary masking coating is adapted to resist to the “electroless” bath, in order to limit the risk of contamination of said “electroless” bath.

### Electrolytic Deposition

For more detail about this metallization method that can possibly be implemented in metallization step D, reference can be made to the technical literature relating to this technology, and for example to the galvanostegy treatises.

### —Step E of Eliminating the Temporary Masking Coating—

In accordance with the above, step E may be carried out:
either (in totality) before metallization step D, in the case in particular where the method comprises a step H of activating the substrate surface previously to metallization step D and where the temporary masking coating is intended to enable a selective activation of the substrate surface;
or (in totality) after step D;
or, more preferentially, (in totality) during metallization step D, or partly during step D and partly after step D, or partly before step D, partly during step D and partly after step D.

As introduced hereinabove, step E advantageously comprises at least one dissolution operation, or even essentially consists of a dissolution, of the temporary masking coating by at least one solvent implemented in the method.

In the hypothesis in which the method comprises a step I of rinsing the surface of the metallized substrate, the step E of eliminating the temporary protection can potentially be carried out either during rinsing step I, or partly during metallization step D and at least partly during said rinsing step I. In the hypothesis in which the method comprises a drying step J, step E of eliminating the temporary protection can potentially be carried out partly during metallization step D and at least partly during said drying step J.

The operation of dissolving the temporary masking coating can be carried out for example by spraying one (or more) aqueous solvent(s), spraying one (or more) organic solvent(s), spraying a mixture of aqueous solvent(s) and organic solvent(s), by immersion into a bath of aqueous solvent(s), by immersion into a bath of organic solvent(s), or by immersion into a bath of a mixture of aqueous solvent(s) and organic solvent(s). Potentially, said dissolution operation can be carried out with a heat input, and be therefore carried out at a temperature of preferentially between 30° C. and 90° C., and more preferentially of between 50° C. and 80° C. In practice, the time at which step E is carried out may depend in particular on how metallization step D is carried out, and in particular on the metallization method(s) implemented during the latter. In particular, the elimination of the temporary masking coating at least partly during metallization step D assumes that the way the latter is carried out enables this elimination and that the residue produced by this elimination is not of nature to interfere with the smooth running of metallization step D.

### Non-Electrolytic Deposition by Projection in the Form of Aerosol(s)

In this embodiment, step E of eliminating the temporary masking coating can be carried out at least partly during step D, in the advantageous case mentioned hereinabove in which a solvent adapted to dissolve the temporary masking coating is contained in the metallization solution, or at least one of the metallization solutions, used during step D.

In practice, even more preferably, the temporary masking coating is alkali-soluble (or at least alkali-sensitive), and the metallization solution (or one of the metallization solutions) have a highly alkaline pH (typically higher than 9), so that the metallization solution(s) can dissolve the temporary masking coating during step D. Typically, during the spraying of the metallization solution(s) in the form of aerosol(s), the unmasked areas of the substrate are metallized, whereas the temporary masking coating is dissolved and evacuated by the effluent, thus letting appear:
either the desired metal pattern(s), in the case where step D is performed after thermoforming step C (variant V1);
or one (or more) corresponding “raw” metal pattern(s), as mentioned hereinabove, in the case where step D is performed before thermoforming step C (variant V2).

It is however preferable that the duration of metallization, i.e. the time required to form the metal deposition in step D, is limited, so as to prevent any risk of metallization of substrate areas that where initially covered with the temporary masking coating.

In this embodiment of spraying aerosol(s), it is possible, as a complement or as an alternative, in particular in the case where the metallization solution(s) used do not contain a solvent adapted to dissolve the temporary masking coating, to rinse, for example by spraying, the masked and metallized surface of the substrate using one or more solvent(s) adapted to dissolve the temporary masking coating. The dissolution of the temporary masking coating is thus accompanied by the evacuation of any metal deposit present at the surface thereof.

### Non-Electrolytic Deposition by Immersion

In this other embodiment, which generally involves implementing an activation step H as described hereinabove, step E can be typically carried out between step H and metallization step D, by applying to the surface of the masked substrate a solvent adapted to dissolve the temporary masking coating. Such an application can be made for example by immersing the masked substrate into said solvent or by spraying said solvent onto the masked substrate surface, followed with a rinsing operation.

This dissolution reveals the activated area(s) of the substrate surface that will be able to receive the metal deposit intended to form the desired metal pattern(s). The area(s) of the substrate surface that were on the contrary previously covered with the temporary masking coating have not been activated (adsorption of the catalyst) in step H, so that no metal deposit is formed thereon during at least the duration required for the formation of a metal deposit on the activated area(s) of the substrate surface.

### Electrolytic Deposition

In this embodiment, step E of eliminating the temporary masking coating can possibly be carried out at least partly during metallization step D, typically in the case where the metallization solution used contains a solvent adapted to dissolve the temporary masking coating and in which the time required for the formation of the metal deposit by electrolytic deposition is advantageously less than or equal to the duration required for the dissolution of the temporary masking coating by said solvent. Alternatively, or possibly as a complement, step E can be carried out after metallization step D, and for example during a step I of rinsing the metallized substrate made using a rinsing liquid containing or forming a solvent adapted to dissolve the temporary masking coating.

### —Step I of Rinsing the Metallized Substrate Surface—

After metallization step D, the method can comprise, as mentioned hereinabove, a step I of rinsing the surface of the metallized substrate. Rinsing step I, like the other rinsing step(s) (in particular, steps P and R) in the method, can be performed by any known and suitable manner, for example by spraying/projection of one (or more) rinsing liquid(s) using an HVLP gun or by soaking/immersion into one or more rinsing liquid(s). The latter is preferably water, and still preferably demineralized water, except possibly in the case where the rinsing liquid contains or forms a solvent (other than water) for dissolving the temporary masking coating.

### —Step J of Drying the Metallized Substrate Surface—

After step I of rinsing the metallized substrate surface, the method can comprise a step J of drying the metallized substrate surface. Drying step J, as potential other drying steps that could occur after each rinsing step, consists in evacuating the rinsing liquid. Such a drying may typically be carried out at ambient temperature by blowing a compressed air flow, for example at a pressure of 5 bar, or using an air knife-type blowing system. It can also be dried in the open air or in an oven.

### —Steps K, L, M of Finishing Treatment of the Metallized Substrate Surface—

One (or more) complementary “finishing” steps can be implemented after metallization step D, and still preferably after thermoforming step C in the case where the latter is carried out after metallization step D, in order for example to protect the metal pattern(s) formed from the metal deposit against physical and/or chemical external aggressions, and/or in order to modify or improve the properties of the metal pattern(s), for example in terms of electrical conductivity and/or optical properties.

As such, the method can possibly comprise a complementary metallization step K (or “thickening step”) by forming at least one additional metal deposit on the surface of the (initial) metal deposit obtained at the end of metallization step D. Such a complementary metallization step K can advantageously be carried out by electrolytic deposition (e.g. galvanostegy) or by non-electrolytic deposition (“electroless”). Said additional metal deposit may or may not have the same composition as the initial metal deposit. For example, the additional metal deposit can comprise, or be formed of, at least one metal chosen among silver, nickel, copper, gold, iron, cobalt, tin, zinc, ruthenium, palladium, one or more oxides of these latter, or one or more alloys of these latter, or a combination thereof. Such a complementary metallization step K may in particular be interesting when the (initial) metallization step D is carried out by non-electrolytic chemical deposition, as contemplated hereinabove, and that is desired to obtain one (or more) metal pattern(s) of a total thickness higher than 5 μm.

As an alternative or as a complement, the method can possibly comprise a step L of passivating the metal deposit(s) forming the metal pattern(s), in order to protect them against corrosion or oxidation. Typically, such a passivation step L may be carried out by spraying of, or immersion into, at least one passivation solution adapted to the composition of the metal deposit(s) forming the metal pattern(s), such as for example a solution of tin inorganic salt(s), an organic precious metal passivation solution as commonly available on the market, or an inorganic solution from the family of silanes or silicon oxides (SiOₓ).

As an alternative or as a complement, the method can possibly comprise—posteriorly to said metallization step D and thermoforming step C, as well as, preferably, posteriorly to step E of eliminating the temporary masking coating—, a step M of forming a covering finishing coating on the substrate surface (metallized thermoformed substrate) carrying the metal pattern(s). Such a finishing coating, organic or inorganic, may constitute a protective coating against mechanical friction, oxidation, etc., and/or an electrically insulating coating, and/or a decorative coating. Step M of forming the finishing coating can be typically carried out by deposition/application, by any known and suitable technique, of at least one finishing layer of a curable and/or cross-linkable liquid composition (e.g., by exposure to UV or thermal curing) on the substrate surface that carries the metal pattern(s). The liquid composition can be a paint or a varnish, advantageously chosen for example among the following group: alkyds, polyurethanes, epoxies, vinyls, acrylics and mixtures thereof. Preferably, the liquid composition is a varnish, potentially coloured/pigmented, advantageously chosen among the following compositions: epoxies, alkyds and acrylics.

### —Over-Moulding Step N—

Optionally, the method according to the invention may comprise, posteriorly to thermoforming step C, a step N of over-moulding the (thermoformed) substrate. Step N may be carried out posteriorly to metallization step D in the case where the latter is carried out after thermoforming step C, or on the contrary previously to metallization step D in the hypothesis that the metal deposit/the metal pattern(s) would risk to be damaged during over-moulding step N. The over-moulding (or injection moulding) step N advantageously consists in injecting a polymer material or a mixture of polymer materials, compatible with the nature of the material of the thermoformed substrate, in a mould inside which has been previously positioned the thermoformed (and preferentially metallized) substrate. Such an over-moulding step advantageously makes it possible, for example, to form a protection and/or support part of the thermoformed (and preferentially metallized) substrate.

### —Step O of Assembling Additional Components—

For certain applications of the three-dimensional item, it may be desired to assemble to the thermoformed substrate provided with the metal pattern(s), over-moulded or not, one (or more) electrical, electronic and/or optoelectronic component(s), through it and/or on the surface of it (electrical connector(s), electrical cable(s)/wire(s), light-emitting diode(s), electronic chip(s), etc.). Advantageously, such an assembly step O can be implemented using one or more robotised surface-mounted component (SMD) placement systems, commonly known as “pick-and-place” or “P&P” machines, one or more robotised arms, or any other known advantageously automated means for depositing liquids/components on a 2.5D or 3D surface. Such an assembly step can advantageously be made by soldering and/or using an electro-conductive adhesive, isotropic or anisotropic, taking for example a film or paste form, and of any suitable chemical nature (silicon, epoxy, acrylic, etc.). If necessary, the electro-conductive adhesive can be cured.

Finally, the method according to the invention has in particular the following advantages:
it makes it possible to manufacture three-dimensional items, of any size and complex shape, provided with decorative/functional metal pattern(s), which can themselves be of great sizes and/or complex shapes;
it makes it possible to manufacture three-dimensional items provided with metal pattern(s) that can be particularly fine, precise and/or complex;
it makes it possible to manufacture three-dimensional items provided with metal pattern(s) that are particularly resistant to external aggressions;
it makes it possible to manufacture three-dimensional items provided with metal pattern(s) that are pattern homogeneous and regular, both in terms of thickness and in terms of surface aspect (very low roughness);
it makes it possible to manufacture three-dimensional items provided with metal patterns in a wide range of conceivable metals (pure metals, metal alloys, metal oxides, etc.);
it makes it possible to manufacture three-dimensional items with metal pattern(s) that may be used in a wide range of technical applications, including some of the most demanding and sensitive ones in terms of metal pattern properties (thinness, thickness, purity, electrical conductivity, roughness, etc.), wherein said metal pattern(s) can be decorative and/or functional, and can therefore advantageously form or contribute to form, for example and with no limitation, one or more printed circuit(s), one or more integrated circuit(s) on a semi-conductive substrate, one or more sensor/detector electrode(s), one or more electrode(s) of an electric heater/defroster device, one or more radio-frequency antenna radiating element(s) (WiFi®, RFID, etc.), one or more encoding pictogram(s) able to be read by electronic devices, one or more figurative and/or scriptural information items identifying a product that incorporates or with which is associated said three-dimensional item, in particular a commercial product, such as a visual or decorative design on packaging, on a car product, etc.;
it can be used in an industrial context for mass production;
it is particularly quick, simple and economical to implement.

Two examples of implementation of a method according to the invention for manufacturing three-dimensional items with metal pattern(s) will now be described in relation to the attached figures. Example 1 illustrates in particular the implementation of variant V1 in which thermoforming step C is carried out before metallization step D, whereas Example 2 illustrates in particular the implementation of variant V2 in which thermoforming step C is carried out after metallization step D.

### Example 1—Manufacturing a Three-Dimensional RFID Antenna

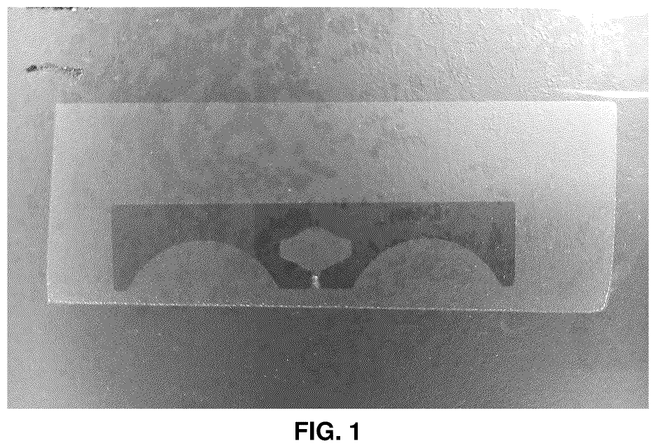

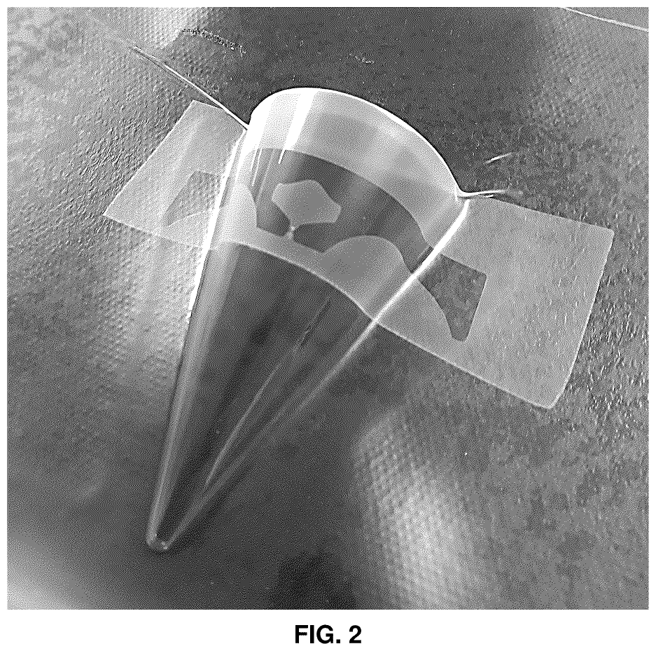

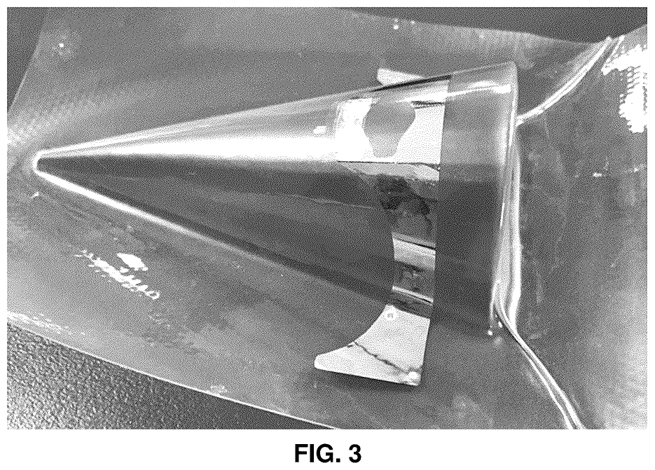

Step A: a flat substrate formed of a polycarbonate film of thickness 250 μm, and 330 mm long by 250 mm wide, is provided;
Step B: a temporary masking coating is formed by screen printing, from a thermoformable and alkali-sensitive masking composition developed by JET METAL TECHNOLOGIES®, on the polycarbonate film. The deposited layer of masking composition is then dried by desolvation at 60° C. for 5 min. As illustrated as an example in FIG. 1, the so-formed temporary masking coating delimits at least one unmasked area (in the centre);
Step C: the film so selectively masked is then homogeneously heated by infrared (IR) up to 215° C., then applied against a counter-shape, in order to be thermoformed. FIG. 2 illustrates an example of thermoformed masked film obtained after cooling and curing;
Step P/Step Q: the surface of the thermoformed masked film is subjected to a treatment for increasing the surface energy by plasma treatment (so-called “air” plasma: 80% nitrogen/20% oxygen at 0.5 mbar (i.e. 50 Pa) for 2 min), so that, at the end of this treatment, the surface energy of the thermoformed masked film is higher than 50 dynes and that said surface can be perfectly wetted by water projection, water then forming a continuous film on the surface of the thermoformed masked film;
Step H: a sensitising solution based on stannous chloride is projected on the surface of the thermoformed masked film for 10 s using an HVLP gun;
Step R: the surface of the thermoformed masked film is rinsed to evacuate the sensitization solution by spraying demineralized water for 10 s using an HVLP gun;
Step D/Step E: a metal deposit is formed on the surface of the thermoformed masked film, sensitized by simultaneous spraying of a first aqueous metallization solution (oxidizing solution) based on silver nitrate with a concentration of 2 g/l and having a pH>9, and a second metallization solution (reducing solution) based on glucose, for 80 s by means of HVLP guns set at a spraying pressure of less than 2.5 bar (i.e. 2.5·10⁵ Pa). Under the effect of alkalinity of the first metallization solution, the alkali-sensitive temporary masking coating is partially degraded and evacuated from the substrate surface with the effluent, thus revealing the desired metallization pattern;
Step I: the surface of the metallized thermoformed film is rinsed with water by means of the HVLP gun. This rinsing makes it possible to evacuate potential residues of the temporary masking coating. A complementary rinsing can possibly be made by immersion into a bath or by spraying solutions containing a solvent of the ethanol/isopropanol type to guarantee a perfect absence of residues of temporary masking coating and metal deposit carried by these latter;
Step J: the surface of the metallized thermoformed film is dried at ambient temperature under an air flow of 5 bar (i.e. 5·10⁵ Pa). The result obtained is illustrated in FIG. 3, in which the thermoformed polycarbonate film and the metal pattern of solid elemental silver obtained at its surface form a three-dimensional RFID antenna;
Step O: an electronic RFID antenna chip is then assembled on the metallized thermoformed film, by soldering or using an electro-conductive adhesive;
Step M: the metallized surface of the so-obtained three-dimensional item is then covered using a protective varnish developed by JET METAL TECHNOLOGIES®.

### Example 2—Manufacturing a Three-Dimensional Item Comprising Decorative Patterns in the Form of Silver Lines

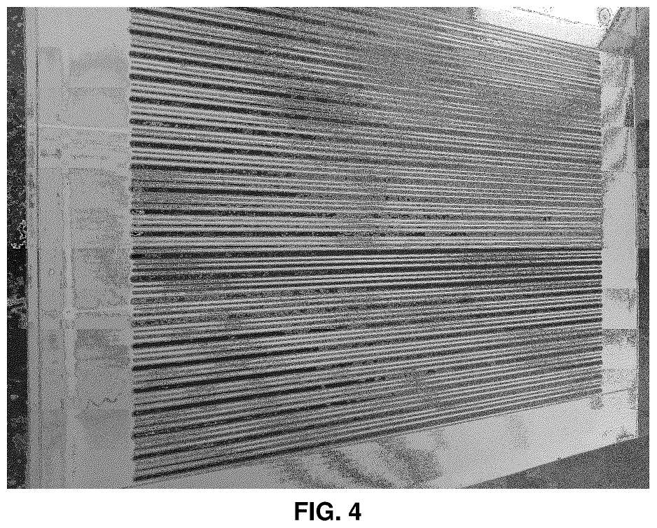

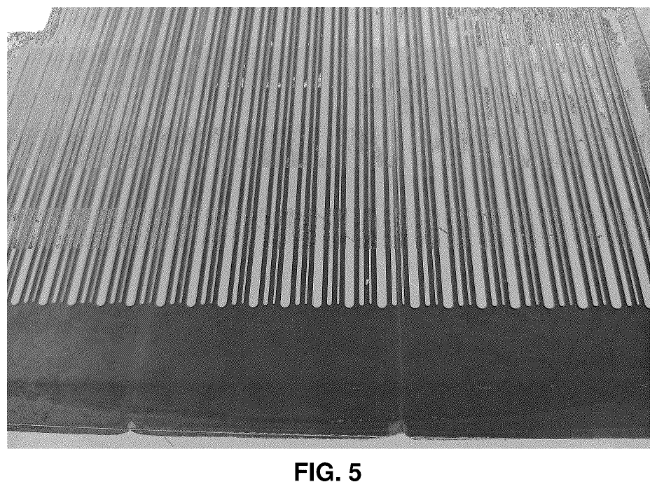

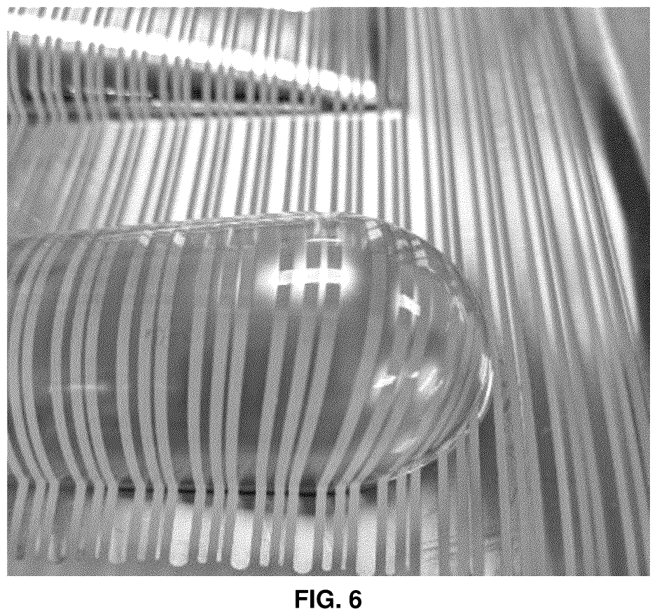

Step A: a flat substrate formed of a polycarbonate film of thickness 250 μm, and 380 mm long by 310 mm wide, is provided;
Step B: a temporary masking coating is formed by screen printing, from an alkali-sensitive masking composition developed by JET METAL TECHNOLOGIES®, on the polycarbonate film. The deposited layer of masking composition is then dried by desolvation at 80° C. for 5 min. As illustrated as an example in FIG. 4, the so-formed temporary masking coating delimits a plurality of unmasked area in the form of lines;
Step P/Step Q: the surface of the masked film is subjected to a treatment for increasing the surface energy by direct ceramic corona treatment, at a speed of 3 m/min and 3 passes, so that, at the end of this treatment, the surface energy of the masked film is higher than 50 dynes and that said surface can be perfectly wetted by water projection, water then forming a continuous film on the surface of the masked film;
Step H: a sensitising solution based on stannous chloride is projected on the surface of the masked film for 10 s using an HVLP gun;
Step R: the surface of the masked film is rinsed to evacuate the sensitization solution by spraying demineralized water for 10 s using an HVLP gun;
Step D/Step E: a metal deposit is formed on the surface of the masked film, sensitized by simultaneous spraying of a first aqueous metallization solution (oxidizing solution) based on silver nitrate with a concentration of 2 g/l and having a pH>9, and a second metallization solution (reducing solution) based on glucose, for 80 s by means of HVLP guns. Under the effect of alkalinity of the first metallization solution, the alkali-sensitive temporary masking coating is partially degraded and evacuated from the substrate surface with the effluent;
Step I: the surface of the metallized film is then consecutively rinsed with water by means of an HVLP for 10 s, then with a rinsing liquid “SelectRinse” developed by JET METAL TECHNOLOGIES® for 15 s using an HVLP gun in order to evacuate any residues of the temporary masking coating, then again with water by means of an HVLP gun.
Step J: the surface of the metallized film is dried at ambient temperature under an air flow of 5 bar (i.e. 5·10⁵ Pa). FIG. 5 illustrates as an example the metallized film so obtained;
Step C: the film so selectively masked is then homogeneously heated by infrared (IR) up to 215° C., then applied against a counter-shape, in order to be thermoformed. FIG. 6 illustrates as an example the thermoformed masked film so obtained after cooling and curing, which can then form the three-dimensional item as such, or being then used to form said three-dimensional item.

### POSSIBILITIES OF INDUSTRIAL APPLICATION

The invention finds an application in the general technical field of three-dimensional items with decorative and/or functional metal pattern(s), and method for manufacturing such items.

1. A method for manufacturing a three-dimensional item comprising at least one metal pattern, comprising at least:
a step A of providing a flat substrate of thermoformable material;
a step B of forming on a surface of the flat substrate a temporary masking coating that adheres to said surface, to obtain a masked substrate having at least one unmasked area;
a step C of thermoforming the flat substrate to give the latter a generally three-dimensional shape;
a step D of metallizing the masked substrate to form a metal deposit on the latter, at least on said unmasked area;
and a step E of eliminating said temporary masking coating,
the thermoforming step C being carried out before metallization step D and before step E of eliminating said temporary masking coating,
the metallization step D being carried out by non-electrolytic deposition from one or more metallization solution(s) containing at least one metal in metal cation form and at least one reducing agent adapted to transform the metal cation into metal, by spraying the metallization solution(s) in the form of one or more aerosol(s).

2. The method according to claim 1, wherein the metal deposit is made of solid metal.

3. The method according to claim 1, wherein the metal deposit has, at the end of the metallization step D, a thickness of between 10 nm and 5 μm, preferably between 10 nm and 1 μm, and still preferably between 10 nm and 500 nm.

4. The method according to claim 1, wherein step D is carried out in such a way that the thickness of the metal deposit is variable over the extent of said metal deposit, the metal deposit having at least a first area and a second area, distinct from each other, the thickness of the metal deposit increasing or decreasing from said first area to said second area.

5. The method according to claim 1, wherein step E of eliminating the temporary masking coating is carried out during metallization step D, or partly during metallization step D and partly after metallization step D, or partly before metallization step D, partly during metallization step D and partly after metallization step D.

6. The method according to claim 1, wherein step E of eliminating the temporary masking coating comprises at least one operation of dissolving the temporary masking coating using at least one solvent implemented in the method, said temporary masking coating being preferably alkali-soluble so that it can be preferentially dissolved by an alkaline solvent implemented in the method.

7. The method according to claim 5, wherein said solvent is contained in the metallization solution or one of the metallization solutions.

8. The method according to claim 1, wherein step B of forming the temporary masking coating is carried out by selectively depositing a layer of a liquid or paste masking composition on the flat substrate surface, for example by screen and/or direct printing, possibly followed by drying and/or curing the layer of masking composition.

9. The method according to claim 1, wherein the temporary masking coating has, at the end its formation step, a thickness of between 100 nm and 50 μm, preferably between 500 nm and 20 μm, and still preferably between 1 μm and 10 μm.

10. The method according to claim 1, wherein the flat substrate is a film, a sheet or a plate of thermoformable polymer material or a composite polymer-matrix thermoformable material, of thickness preferentially between 8 μm and 15 mm, and still preferably between 25 μm and 10 mm.

11. The method according to claim 1, which comprises a step G of defining a two-dimensional masking pattern, along which the temporary masking coating is then formed on the flat substrate surface, by modelling the deformation of the flat substrate in thermoforming step C and representing the metal patterns to be obtained.

12. The method according to claim 1, which comprises, posteriorly to thermoforming step C, a step N of over-moulding the substrate.
